(19) United States
(12) Patent Application Publication
(10) Pub. No.: US 2004/0025280 A1
(43) Pub. Date: Feb. 12, 2004

(54) Wiper blade for cleaning glass panes, especially of motor vehicles, and method for the production of said wiper blade

(76) Inventors: Otto Krickau, Stuttgart (DE); Peter De Block, Halen (BE)

Correspondence Address: Striker Striker & Stenby, 103 East Neck Road, Huntington, NY, 11743, US

(21) Appl. No.: 10/276,467

(22) PCT Filed: Feb. 26, 2002
(86) PCT No.: PCT/DE02/00703

(30) Foreign Application Priority Data
Mar. 21, 2001 (DE) 101 13 657.9

(51) Int. Cl. B60S 1/40; B60S 1/38

(52) U.S. Cl. 15/250.32; 15/250.43

(57) ABSTRACT

A wiper blade is proposed for cleaning windows, especially of motor vehicles, is proposed, which is provided with an elongated, rubber-elastic wiper strip that can be placed against the window, which wiper strip is disposed on the lower band face (13), oriented toward the window, of a bandlike-elongated support element (12) made from a spring-elastic steel, on whose other, upper band face (11) facing away from the middle, particularly in the middle portion of the support element, a device (15) for connecting the wiper blade to the free end, urged toward the window, of a driven wiper arm (16) guided on the motor vehicle is welded. It has proved particularly advantageous, in view of the demands made of the support element, if the support element is made from an alloyed quenched and tempered steel, which has the following alloy components: carbon (C), 0.18% to 0.36%; silicon (Si), 0.40% to 0.50 %; manganese (Mn), 1.10 % to 1.80%; phosphorus (P), 0.015% to 0.035%; and sulfur (S), 0.035% to 0.04%.

### PRIOR ART

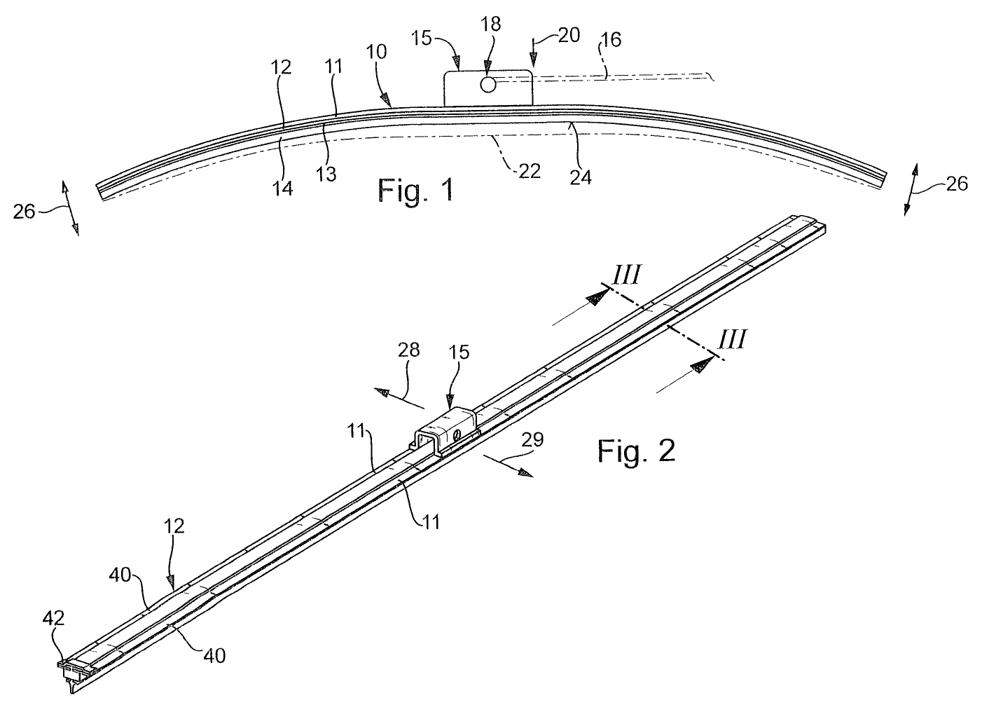

In wiper blades of the type defined by the preamble to claim 1, the support element is meant to assure the most uniform possible distribution, over the entire field swept by the wiper blade, of the wiper blade contact pressure, originating in the wiper arm, against the window. By means of a suitable shaping curvature of the unstressed support element—that is, when the wiper blade is not resting on the window (FIG. 1)—the ends of the wiper strip, which in wiper blade operation presses completely against the window, are stressed toward the window by the then-tensed support element, even if the radii of curvature of spherically curved vehicle windows change at every position of the wiper blade. The curvature of the wiper blade must accordingly be somewhat greater than that in the swept field, at the most pronounced measured curvature of the window to be wiped, because during wiper operation, the wiper strip, or its wiper lip resting on the window, must press against the window with a defined pressure. If this force exceeds a certain magnitude, however, the drive unit—that is, the electric motor and a gear downstream of it—is overloaded, while if the contact pressure is slight, the quality of window cleaning suffers. It is therefor a major demand made of the support element that it have a long service life at the predetermined shaping curvature, within relatively narrow tolerances, because this is responsible for the proper distribution of the contact pressure originating in the wiper arm. Moreover, the requisite crosswise reinforcement of the rubber-elastic wiper strip is effected solely by the support element. The support element thus replaces the known, complicated support bracket construction with two spring rails, of the kind used in conventional wiper blades (German Published, Nonexamined Patent Application DE-OS 15 05 257). In such a wiper blade, the contact pressure exerted toward the window on a main bracket by a wiper arm is transmitted to two claw brackets, and from there via four claws to the rubber-elastic wiper strip. The two spring rails of this wiper blade primarily assure crosswise reinforcement of the wiper strip between the claws, when the wiper blade is displaced over the window crosswise to the length of the wiper strip.

In a know wiper blade of the type defined by the preamble to claim 1 (German Patent 12 47 161), the connection device for the wiper arm is riveted to the support element. The bores required in the support element for this purpose affect its spring properties in a way that can be controlled only with great difficulty, since the microstructure created in the production of the starting material is interrupted at multiple points.

In another known wiper blade of this generic type (German Patent 26 14 457), the connection device is joined integrally with the support element, because the connection device is formed by two tabs bend upward on the support element. Producing the requisite relatively sharp-edged bending edge for this purpose makes certain demands of the available material for the support element, but these demands run counter to he need for great durability of the spring properties of the support element.

In another known wiper blade of this type (German Patent Disclosure DE 197 18 490.1), the connection device is welded to the support element. However, in the spring band steels used to produce the spring rails for the known, aforementioned bracket-system wiper blades, this intrinsically single, economical welded connection, which moreover affects the spring properties of the support element only insignificantly, leads to the formation of pores and microscopic cracks from brittleness in the welded region, as well as rehardening zones in the weld seam and the like. These problems can be only partly eliminated by providing an intermediate thermal treatment, which is expensive. Besides, in such steels, satisfactory quality in such other steps in the production process for the support element provided with the connection device, such as painting, which is done to avoid the irritating reflection in bare steels, is hardly attainable. Also in these spring band steels, the requisite dimensional stability for the shaping curvature, which is ascertained specially for every kind of window contour, is not permanently assured; nor is it assured that the required tolerances will be met over the long term. These steels can accordingly be used without limitation only for wiper blades for flat windows, where the support element is under only static stress.

### ADVANTAGES OF THE INVENTION

In the wiper blade of the invention, having the definitive characteristics of claim 1, a wiper blade is obtained whose support element, because of its relatively low carbon content can be welded well. In the region of the weld connection, there is no brittleness, thus avoiding the adverse effects of brittleness there. The only slight proportions of phosphorus and sulfur contribute further in this respect. A wiper blade with a support element of this kind is especially well suited to wiping windows that have a moderate spherical curvature.

If in a refinement of the invention the quenched and tempered steel used for the support element also has a proportion of chromium of 0.30% to 0.60% and moreover has a proportion of boron of at least 0.008%, a wiper blade is obtained whose support element has only very slight relaxation in its yielding direction and moreover has improved properties in terms of hardenability, weldability, and reformabilty.

Further improvement in terms of the demands made of the support element of the wiper lip is attained if the quenched and tempered steel for producing the support element has the following alloy components: carbon, 0.24% to 0.36%; silicon, 0.40%; manganese, 1.10% to 1.50%; phosphorus, 0.035%; sulfur, 0.035% to 0.40%; chromium, 0.30% to 0.60%, and boron, at least 0.008%. In such a support element, nor only are the aforementioned properties in terms of dimensional stability, hardenability, weldability, and great durability of the shaping curvature improved, but the problematic weld connection zone can be embodied in a problem-free way, and good paintability is achieved.

In another refinement of the invention, following further alloy components are added to the quenched and tempered steel for producing the support element: aluminum, 0.04% and niobium, 0.03%. These alloy ingredients likewise improve the hardenability, weldability, and reformabilty of the wiper blade support element.

It proves especially favorable if, in an alternative proposal, the quenched and tempered steel for producing the support element has the following alloy components: carbon, 0.18%; silicon, 0.50%; manganese, 1.80%; phosphorus, 0.015%; sulfur, 0.002%; aluminum, 0.04% and niobium, 0.03%. In this kind of quenched and tempered steel as well, the aforementioned deficiencies in the region of the problematic welding zone no longer arise. The hardenability and reformability are improved decisively in this case, as is the durability of the shaping,

In a method for producing a bandlike-elongated support element made from a spring-elastic quenched and tempered steel and belonging to a wiper blade, it has proved especially advantageous if as the starting material for the support element, a wire of round cross section is used, which is shaped without waste into a band by cold rolling on two opposed sides. In this method, the microstructure of the material resulting from the drawing of the wire is not interrupted but only reformed, which is advantageous particularly for the shaping curvature of the support element.

Other advantageous refinements and features of the invention are disclosed in the ensuing description of exemplary embodiments shown in the associated drawing.

### DRAWING

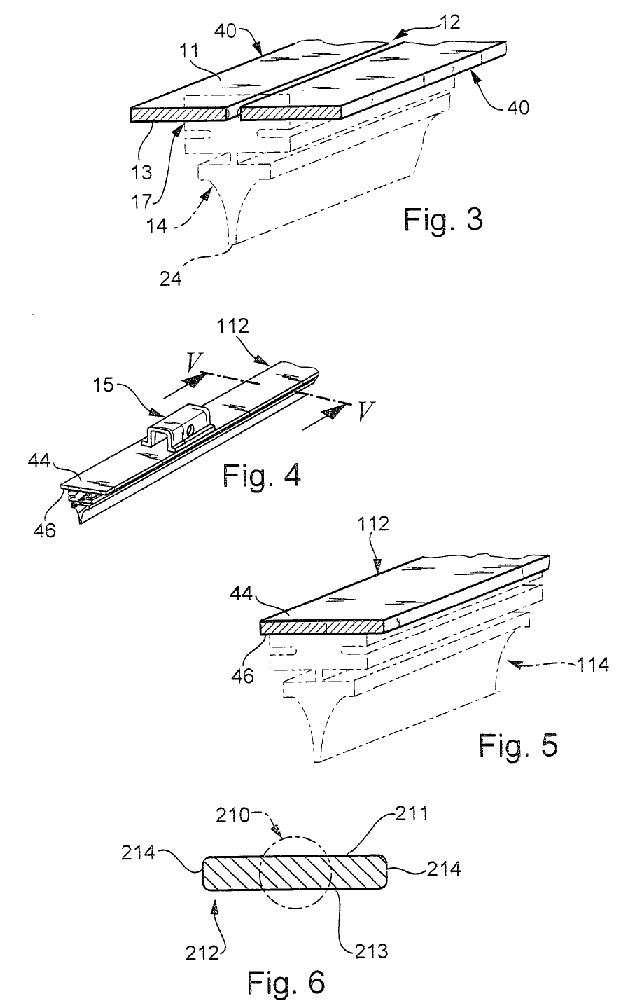

In the drawing, FIG. 1 is a basic illustration of a wiper blade of the invention in a side view; FIG. 2 is a fragmentary side view of a first embodiment of the wiper blade of FIG. 1, shown stretched out and in perspective; invention; FIG. 3 is a section through the wiper blade of FIG. 2 taken along the line III-III, on a larger scale; FIG. 4 shows the arrangement of FIG. 3 for a different embodiment of the wiper blade shown; FIG. 5 is a section through the wiper blade of FIG. 4 taken along the line V-V on a larger scale; and FIG. 6, not to scale, shows the cross section of a support element belonging to the wiper blade.

### DESCRIPTION OF THE EXEMPLARY EMBODIMENTS

A wiper blade 10 shown in FIG. 1 has a bandlike-elongated, spring-elastic support element 12 (FIGS. 2 and 3), to whose lower side 13, oriented toward the window, an elongated, rubber-elastic wiper strip 14 is secured parallel to the longitudinal axis. In the middle of the underside of the support element 12, which can also be called a spring rail, is a connection device, with whose aid the wiper blade 10 can be joined separably and pivotably to a driven wiper arm 16, represented by dot-dash lines. To that end, the wiper arm 16 is provided on its free end with the part 18 of the connection device toward the wiper arm, this part not being shown in detail. The wiper blade 16 is urged in the direction of the arrow 20 toward the window to be wiped—such as a motor vehicle windshield—whose surface is suggested in FIG. 1 by a dot-dash line 22. Since the line 22 is meant to represent the most pronounced curvature of the window surface, it is quite clear that the shaping curvature of the still-unloaded wiper blade, which is resting with both of its ends on the window, is more pronounced than the maximum curvature of the window (FIG. 1). Under the contact pressure (arrow 20), the wiper blade 10 presses over its entire length, with its wiper lip 24, against the surface 22 of the window to be wiped. In the process, a tension builds up in the spring-elastic metal support element, and this tension assures a proper contact of the wiper strip 14, or wiper lip 24, over its entire length with the window and also assures an even distribution of the contact pressure (arrow 20). Since the window, which as a rule is spherically curved, is not a portion of a globular surface, the wiper blade 10 in its reciprocating wiping motion (arrows 28 and 29 in FIG. 2) relative to the wiper arm 16 that occurs over its crosswise or lengthwise extent must be capable of constantly adapting to the position of the window surface at the time. Moreover, the wiper blade 10, or the wiper strip 14 with its wiper lip 24, but also be able to adapt tot he constantly changing course of the window curvature during wiping operation, as indicated by the two double arrows 26 in FIG. 1. This oscillating motion extends—becoming less and less—from the ends of the wiper blade 10, or support element 12, to the part 15 of the connection device toward the wiper blade. The weld connection is subjected to a permanent alternating stress in the process.

It can be seen clearly from FIGS. 2 and 3 that the support element 12 made from a spring-elastic steel has spring rails 40 spaced apart from one another and extending to one another. The two spring rails are disposed with their inner edges, facing one another, in peripherally open longitudinal grooves in the wiper strip 14, the wiper strip being represented here by dot-dash lines. These spring rails are fixed on both ends relative to one another by bridgelike crosspieces 42. The part 15 of the connection device disposed in the middle region of the wiper blade 10 or of the support element 12 also contributes to this fixation. Both the part 15 of the connection device and the bridgelike crosspieces 42 are disposed on the upper band face 11 and are welded to the two spring rails 40. In the exemplary embodiment, the support element is thus reinforced in the region of the part 15, while the two portions between the ends of the support element and the part 15 can execute the requisite oscillating motion (double arrows 26). The two spring rails 40 rest in laterally peripherally open longitudinal grooves 17, assigned to the spring rails, in the wiper strip 14 (FIG. 3), so that they are retained on the support element 12.

In the embodiment of the wiper blade in FIGS. 4 and 5, the support element 112 is embodied as a one-piece band, in whose middle portion the part 15 of the connection device toward the wiper blade is welded to the upper band face 44, pointing away from the window. The rubber-elastic wiper strip 114 is secured to the lower band face 46, oriented toward the window, for instance being glued to it or vulcanized onto it. In this case as well, the middle portion of the support element 112 that is firmly joined to the part 15 is reinforced, while the two free portions of the wiper blade or of the support element are capable of executing the requisite oscillating motion (double arrows 26).

It has now been found that in the production of the support element 40, 15, 42 or 112, 15 using spring steels—as in the case of the spring rails of the wiper blade of German Published, Non-Examined Patent Application DE-OS 15 05 257—considerable problems can arise. Such steels are know and spring steel C 75, for example. However, for the weld connection, which is indispensable for the wiper blade of the invention, these steels are unsuitable, because after the welding they can have pores, microscopic cracks, a rehardening zone in the weld seam, and hence a severe reduction in strength. Moreover, corrosion problems occur in the region of the weld. These deficiencies cannot be overcome even by means of an expensive posttreatment performed subsequently.

Stainless spring steels also lend themselves poorly to painting, which means there is a risk of glare, which can blind and annoy the driver of the vehicle.

There is accordingly a great need to find a suitable spring steel that avoids all these disadvantageous and moreover has especially good reforming properties. The shaping curvature (see FIG. 1) should also have the greatest possible durability. The weld connection between the part 15 of the connection device and the support element 12 or 112, or between the crosspieces 42 and the support element 12, should be corrosion-resistant and should not have any pores or cracks, so that during the oscillating motion (arrows 26 in FIG. 1) that occurs constantly during wiper operation, fatigue fractures in the region of the weld connection will not occur.

It has been found that these requirements are largely met by a quenched and tempered steel that has the following alloy components: carbon (C), 0.18% to 0.36%; silicon (Si), 0.40% to 0.50%; manganese (Mn), 1.10% to 1.80%; phosphorus (P), 0.015% to 0.035%; and sulfur (S), 0.035% to 0.04%. Such steels are suitable at least for wiper blades for windows whose spherical curvature is within certain limits. A marked improvement in terms of the desired properties of the spring steel is attained if following further alloy components are also added to the above-described spring steel: chromium (Cr), 0.30% to 0.60%, and boron (B), at least 0.008%. By the addition of the chromium alloy component, the relaxation is improved considerably, while by the addition of boron, the hardenability, weldability and reformability of the support element are improved considerably in view of the demands made of this support element.

For support elements that are intended to be used for producing wiper blades for wiping windows with relatively short radii of curvature, it has proved to be especially advantageous if that the economical quenched and tempered steel used for producing the support element has the following alloy components: carbon (C), 0.24% to 0.36%; silicon (Si), 0.40%; manganese (Mn), 1.10% to 1.50%; phosphorus (P), 0.035%; sulfur (S), 0.035% to 0.40%; chromium (Cr), 0.30% to 0.60%, and boron (B), at least 0.008%.

However, it has also been found that the aforementioned quenched and tempered steel, which has only the alloy ingredients of carbon, silicon, manganese, phosphorus and sulfur, is also markedly improved in terms of the properties needed if it also has aluminum (Al), 0.04% and niobium (Nb), 0.03% as further alloy components. Another advantage of such a steel is considered to be that it can be bent, without disadvantages, with a radius equal to four times the thickness of the material. For instance, a hook for attaching the wiper arm directly to the support element can be formed on in this way.

It is especially favorable in this case if such a quenched and tempered steel has the following alloy components: carbon (C), 0.18%; silicon (Si), 0.50%; manganese (Mn), 1.80%; phosphorus (P), 0.015%; sulfur (S), 0.002%; aluminum (Al), 0.04% and niobium (Nb), 0.03%. How the various additives proposed will each affect the properties of a It should be familiar to one skilled in the art. However, in terms of the individual components and their proportions, the additives proposed according to the invention are of particular significance for the support elements of the kind of interest here.

In an extraordinarily favorable method for producing a bandlike-elongated support element, made from a spring-elastic quenched and tempered steel, belonging to a wiper blade, as the starting material a wire of round cross section is used, which is shaped without waste into a band by cold rolling on two opposed sides. This method can be employed both for the two spring rails (FIG. 2) and for the spring band 112 (FIG. 4). FIG. 6 therefore shows the configuration of both a section through a spring rail 40 and a section through the support element 112. The internal microstructure of the material that results in the reforming has an especially favorable effect on the durability of the dynamically loaded shaping curvature of the support element. As can be seen from FIG. 6, the wire used there as the starting material is shown in dot-dash lines and is identified by reference numeral 210. After the cold rolling, the result is a band 212 that has been reformed without waste, and both of whose opposed flat sides 211 and 213—which now form the top and bottom sides of the support element—are shaped without waste. The two opposed longitudinal sides 214 now have rounded edges, which improve the spring properties of the support element and which are also favorable in terms of reducing the risk of injury when a person is handling the wiper blade.

In this production method, it is possible for the aforementioned reforming of the starting material to be done directly from the roll of wire itself, and after that to cut the resultant band to length as needed.

However, it is also possible to cut wire blanks from the roll and then to reform the resultant wire segments accordingly.

The other method steps for producing the support element (straightening, producing the shaping curvature, hardening, quenching and tempering, welding, etc.) can then be done in whatever order is appropriate for production.

1. A wiper blade (10) for cleaning windows, in particular of motor vehicles, having a rubber-elastic wiper strip (14) that can be placed against the window to be wiped, and the wiper strip is disposed on the lower band face (13 or 113), oriented toward the window, of a bandlike-elongated support element (12 or 112) made from a spring-elastic steel, on whose other, upper band face (11 or 111) facing away from the middle, particularly in the middle portion of the support element, a device (15) for connecting the wiper blade to a wiper arm (16) is welded, characterized in that the support element (12 or 112) is made from an alloyed quenched and tempered steel, which has the following alloy components: carbon (C), 0.18% to 0.36%; silicon (Si), 0.40% to 0.50%; manganese (Mn), 1.10% to 1.80%; phosphorus (P), 0.015% to 0.035%; and sulfur (S), 0.035% to 0.04%.

2. The wiper blade of claim 1, characterized in that the quenched and tempered steel for producing the support element has the following further alloy components: chromium (Cr), 0.30% to 0.60%, and boron (B), at least 0.008%.

3. The wiper blade as defined by the preamble to claim 1 and in particular as defined by claim 2, characterized in that the quenched and tempered steel for producing the support element has the following alloy components: carbon (C), 0.24% to 0.36%; silicon (Si), 0.40%; manganese (Mn), 1.10% to 1.50%; phosphorus (P), 0.035%; sulfur (S), 0.035% to 0.40%; chromium (Cr), 0.30% to 0.60%, and boron (B), at least 0.008%.

4. The wiper blade of claim 1 or 3, characterized in that the quenched and tempered steel for producing the support element has the following further alloy components: aluminum (Al), 0.04% and niobium (Nb), 0.03%.

5. The wiper blade as defined by the preamble to claim 1 and in particular as defined by claim 4, characterized in that the quenched and tempered steel for producing the support element has the following alloy components: carbon (C), 0.18%; silicon (Si), 0.50%; manganese (Mn), 1.80%; phosphorus (P), 0.015%; sulfur (S), 0.002%; aluminum (Al), 0.04% and niobium (Nb), 0.03%.

6. A method for producing a bandlike-elongated support element (12), made from a spring-elastic quenched and tempered steel, belonging to a wiper blade (10) of one of claims 1-5, characterized in that the starting material is a wire (210) of round cross section, which is shaped without waste into a band (214) by cold rolling on two opposed sides (211, 213).

7. A wiper blade (10) for cleaning windows, in particular of motor vehicles, having a rubber-elastic wiper strip (14) that can be placed against the window to be wiped, and the wiper strip is disposed on the lower band face (13 or 113), oriented toward the window, of a bandlike-elongated support element (12 or 112) made from a spring-elastic steel, on whose other, upper band face (11 or 111) facing away from the middle, particularly in the middle portion of the support element, a device (15) for connecting the wiper blade to a wiper arm (16) is welded, characterized in that the support element (12 or 112) is made from an alloyed quenched and tempered steel, which has the following alloy components: carbon (C), 0.18% to 0.36%; silicon (Si), 0.40% to 0.50%; manganese (Mn), 1.10% to 1.80%; phosphorus (P), 0.015% to 0.035%; and sulfur (S), 0.035% to 0.04%.

8. The wiper blade of claim 7, characterized in that the quenched and tempered steel for producing the support element has the following further alloy components: chromium (Cr), 0.30% to 0.60%, and boron (B), at least 0.008%.

9. The wiper blade as defined by claim 8, characterized in that the quenched and tempered steel for producing the support element has the following alloy components: carbon (C), 0.24% to 0.36%; silicon (Si), 0.40%; manganese (Mn), 1.10% to 1.50%; phosphorus (P), 0.035%; sulfur (S), 0.035% to 0.40%; chromium (Cr), 0.30% to 0.60%, and boron (B), at least 0.008%.

10. The wiper blade of claim 7, characterized in that the quenched and tempered steel for producing the support element has the following further alloy components: aluminum (Al), 0.04% and niobium (Nb), 0.03%.

11. The wiper blade as defined by the preamble to claim 1 and in particular as defined by claim 10, characterized in that the quenched and tempered steel for producing the support element has the following alloy components: carbon (C), 0.18%; silicon (Si), 0.50%; manganese (Mn), 1.80%; phosphorus (P), 0.015%; sulfur (S), 0.002%; aluminum (Al), 0.04% and niobium (Nb), 0.03%.

12. A method for producing a bandlike-elongated support element (12), made from a spring-elastic quenched and tempered steel, belonging to a wiper blade (10) of claim 7, characterized in that the starting material is a wire (210) of round cross section, which is shaped without waste into a band (214) by cold rolling on two opposed sides (211, 213).
